(19) United States
(12) Patent Application Publication
(10) Pub. No.: US 2020/0276871 A1
(43) Pub. Date: Sep. 3, 2020

(54) DEVICE FOR UNSEATING TIRE BEADS FROM RIMS

(71) Applicant: RD MALENFANT INC., Iberville (CA)

(72) Inventor: David MALENFANT, Iberville (CA)

(21) Appl. No.: 16/730,533

(22) Filed: Dec. 30, 2019

Related U.S. Application Data
(63) Continuation of application No. 14/440,310, filed on May 1, 2015, now abandoned.
(60) Provisional application No. 61/721,355, filed on Nov. 1, 2012.

(51) Int. Cl. B60C 25/13; B60C 25/02

(52) U.S. Cl. CPC B60C 25/13; B60C 25/02

(57) ABSTRACT

A device for unseating tire beads of a tire from a rim comprises facing mobile upper and fixed lower jaws adapted to receive the tire horizontally therebetween. The upper jaw is mounted to a pivotable parallelogram linkage which is displaced by a pneumatic cylinder, whereby the actuation of the cylinder displaces the linkage which drives the upper jaw downwardly onto the upper sidewall of the tire, adjacent the rim, with the lower sidewall of the tire being engaged by the lower jaw. The upper and lower jaws are substantially vertical and plane plates. An adjustable tire abutment is provided for positioning the tire within the device such that the upper and lower jaws face respective sidewalls of the tire adjacent the rim. Another device is adapted to vertically receive the tire between the jaws thereof, so as to be unseated from the rim in a vertical position.

### CROSS REFERENCE TO RELATED APPLICATIONS

This Application claims priority on U.S. Provisional Application No. 61/721,355, now pending, filed on Nov. 1, 2012, which is herein incorporated by reference.

### FIELD

The present invention relates to wheels and, more particularly, to devices for detaching tires from rims.

### BACKGROUND

When it is required to remove a tire from a rim, it is a physically difficult task as over time the tires, i.e. the inner circular beads that define the tire's central opening, have “adhered” to the rims. This task is presently carried out with a sledgehammer, by repeatedly hitting the tire sidewall near the rim while the tire is laid on the ground. This method damages the rims, is physically demanding and there is a high risk of injuries.

Various devices have been proposed to detach the tire's beads from the rim onto which the tire is mounted. Other devices are used to then remove the tire from the rim. Regarding devices for separating the tire's beads from the its rim, there are two main types of systems, namely hook-based systems that slide in to separate the tire bead from the rim by pulling the tire away from the rim, and bead breaker systems, which use a jaw pushed on the tire's sidewall to detach the tire bead from the rim.

Therefore, there is a need for a device for detaching a tire's beads from the rim carrying the tire.

### SUMMARY

It is therefore a present aim to provide a novel device for unseating tire beads from rims.

Therefore, there is provided a device for unseating beads of a tire from a rim onto which the tire is mounted, comprising first and second facing tire-engaging members adapted to receive the tire therebetween and adapted to move relative to one another towards the tire so as to engage the tire adjacent the rim, said first and second tire-engaging members being adapted for engaging first and second sidewalls of the tire such that a displacement of the first and second tire-engaging members towards each other causes said tire-engaging members to engage the first and second sidewalls of the tire so as to detach the tire from the rim.

### BRIEF DESCRIPTION OF THE DRAWINGS

Reference will now be made to the accompanying drawings, showing by way of illustration an illustrative embodiment of the present invention, and in which:

FIGS. 1 and 2 are front and rear perspective representations of a device for unseating tire beads from rims;

FIG. 3 is a perspective schematic representation of the device of FIGS. 1 and 2 but without a pneumatic cylinder thereof, and with a tire/rim being shown in dotted lines;

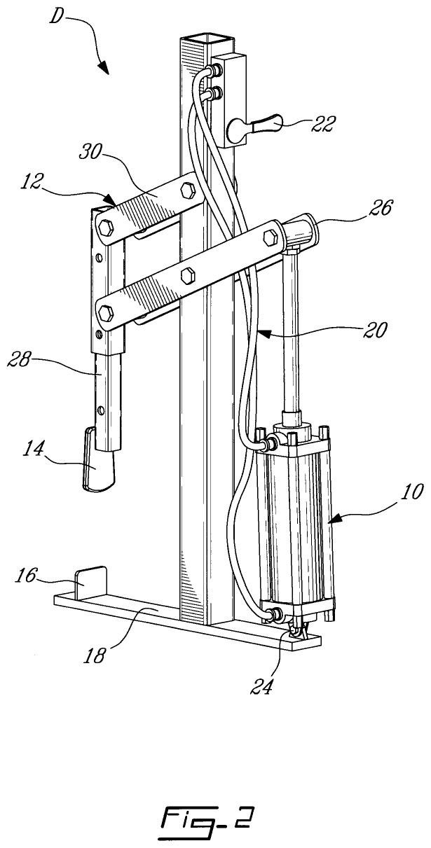

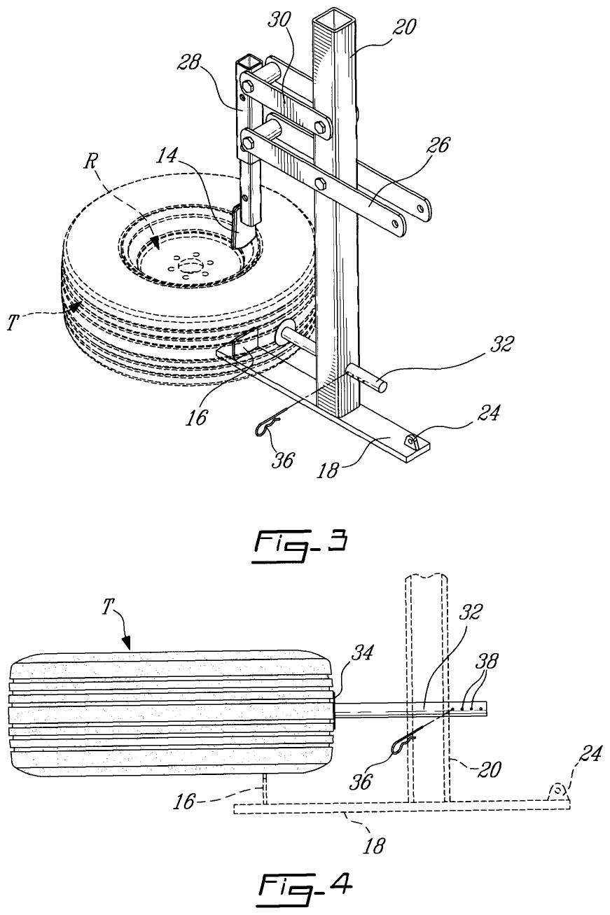

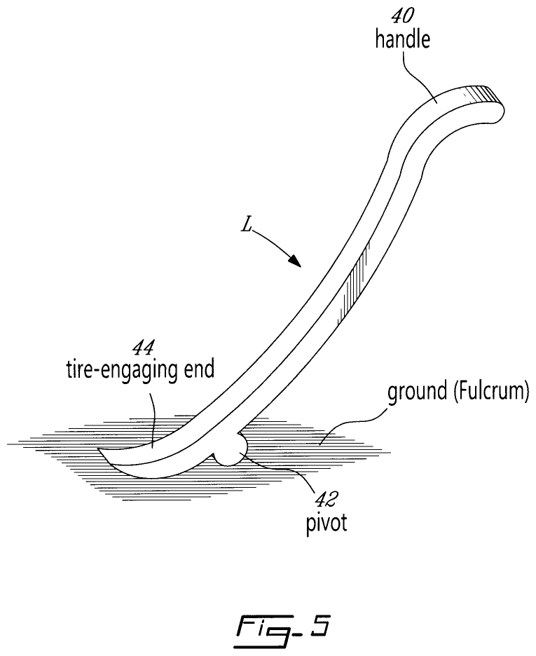

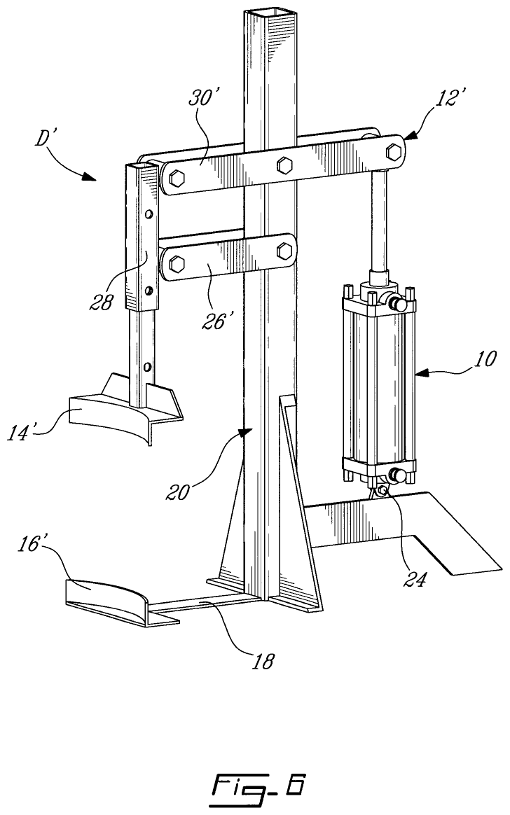

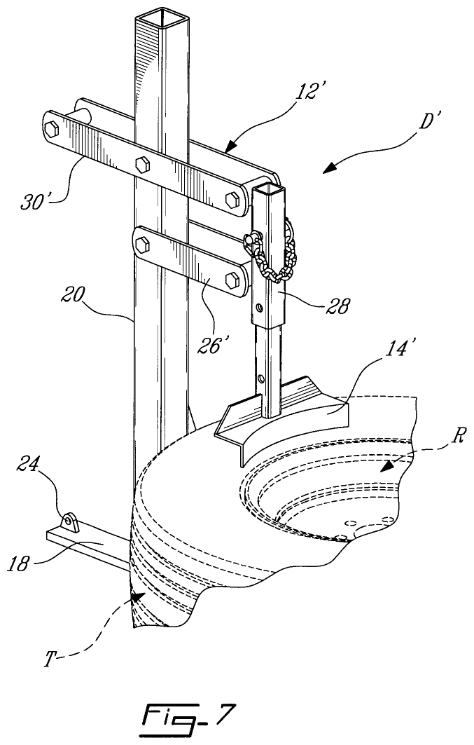

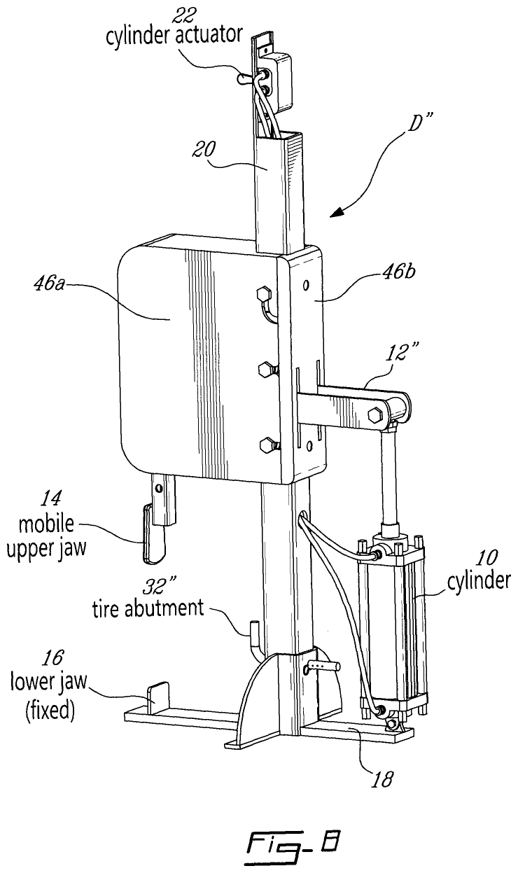

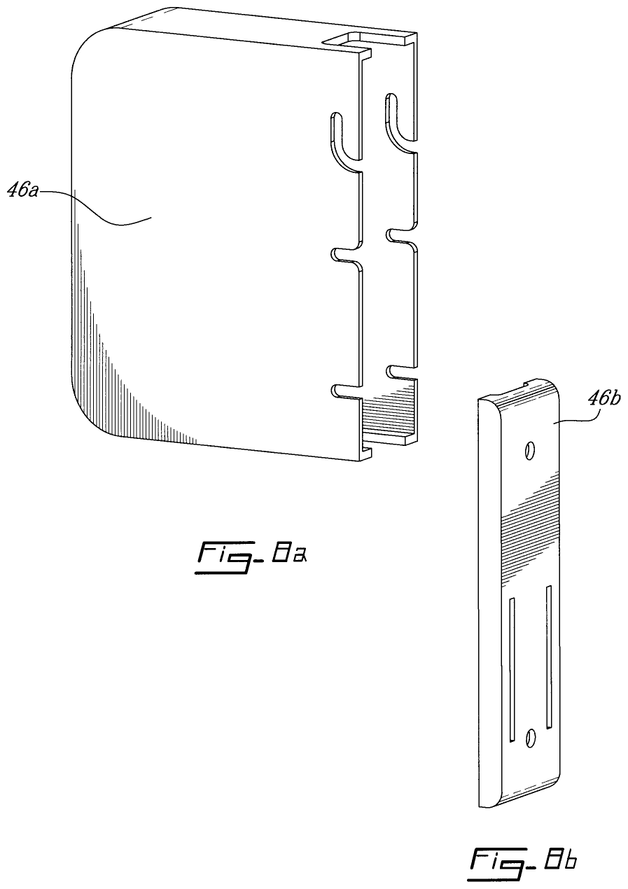

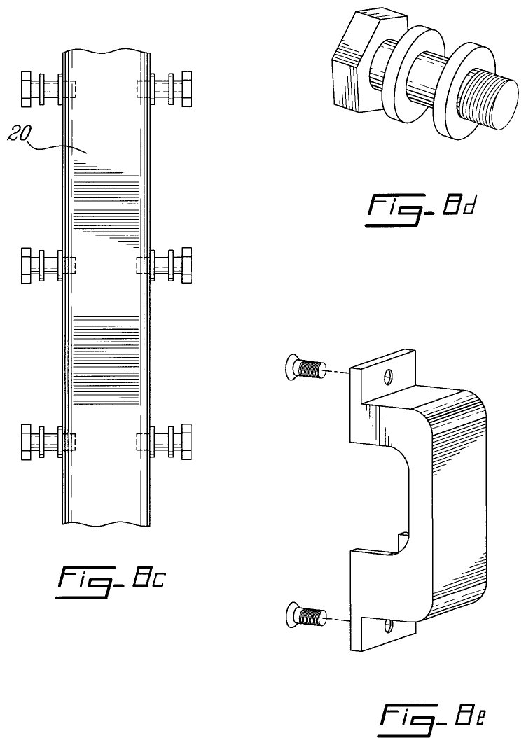

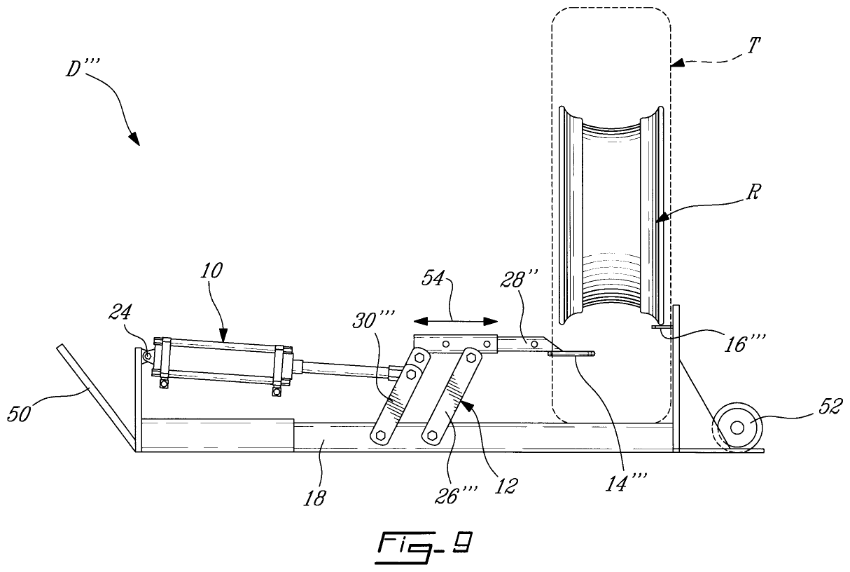

FIG. 2 is a side schematic representation of part of the device of FIG. 3;

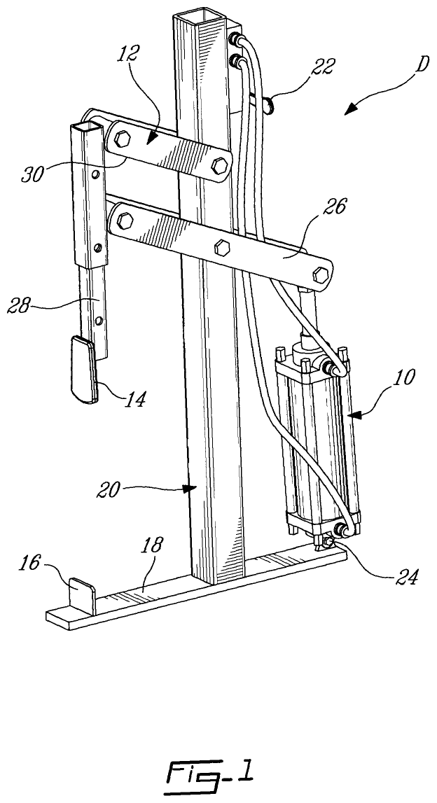

FIG. 5 is a perspective schematic representation of a tool used in combination with the device of FIGS. 1 to 4;

FIG. 6 is a perspective representation of a second embodiment of a device for unseating tire beads from rims;

FIG. 7 is a perspective representation of the device of FIG. 6 shown in use on a tire;

FIG. 8 is a perspective representation of a third embodiment of a device for unseating tire beads from rims, which is similar to the device of FIG. 1;

FIGS. 8a to 8e are components of the device of FIG. 8; and

FIG. 9 is a side elevation view of a fourth embodiment of a device for unseating tire beads from rims.

### DESCRIPTION OF ILLUSTRATIVE EMBODIMENTS

With reference to FIGS. 1 to 4, a device D for unseating beads of a tire T from a rim R onto which the tire T is mounted will now be described.

Generally, the present device D includes a pneumatic cylinder 10, a lever system 12 (parallelogram linkage), an upper jaw 14, a lower jaw 16 resting on a base 18, and a center body 20 which acts as a fulcrum for the lever system 12. The cylinder 10 is operated by an actuator (switch) 22.

In a preferred embodiment, the pneumatic cylinder 10 is pivotally mounted at 24 to the base 18 and a piston section of the cylinder 10 is pivotally connected to rear end of a lower lever arm 26. The upper jaw 14 is mounted to a lower end of a front arm 28, which has a pair of telescopic sections for adjusting its length and thus the elevation of the upper jaw 14. The lower lever arm 26 is pivotally connected at a front end thereof to the front arm 28. Intermediate the pneumatic cylinder 10 and the front arm 28, the lower lever arm 26 is pivotally connected to the center body 20, such that the center body 20 serves as a fulcrum between the pneumatic cylinder 10 and the upper jaw 14.

An upper lever arm 30 is pivotally connected at a rear end thereof to the center body 20 and at a front end thereof to an upper end of the front arm 28, such that lower lever arm 26 may pivot, but be stabilized by the upper lever arm 30. The lower lever arm 26, the upper lever arm 30, the front arm 28 and the center body 20 form the lever system 12.

As seen in FIGS. 3 and 4, an adjustable abutment rod 32 extends horizontally through the center body 20, opposite a threaded section of the tire T. The position of the abutment rod 32 is adjusted so that when a front enlarged end 34 thereof abuts the tire T (see FIG. 4), the tire T is positioned within the device D such that the upper and lower jaws 14 and 16 are located vertically opposite both sidewalls of the tire T at locations thereof which are adjacent the rim R so that the jaws 14 and 16 act on the tire T for efficiently unseating the beads of the tire T from the rim R. A cotter pin 36 and a series of holes 38 defined in the abutment rod 32 are herein used for allowing the position of the enlarged end 34 relative to the lower jaw 16.

In operation, the position of the abutment rod 32 is adjusted relative to the center body 20 in view of the configuration of the tire T, typically its height, such as to ensure that when the tire T abuts the enlarged end 34, the upper and lower jaws 14 and 16 are located vertically opposite the sidewalls of the tire T adjacent the rim R. The tire T can then be placed on the base 18, resting along its diameter, such that the lower jaw 16 rests onto the lower sidewall of the tire T and very close to the rim R.

When the pneumatic cylinder 10 is engaged by the switch 22 it emits a force upwards on the lower lever arm 26. This lower lever arm 26 produces a downward force on the upper jaw 14 such that it descends downwards and towards the upper sidewall of the tire T. In this manner, when the pneumatic cylinder 10 is engaged and the upper jaw 14 is sufficiently driven thereby downwards and against the tire T, the bead of the upper sidewall of the tire T detaches from the rim R, while the lower jaw 16 causes the bead of the lower sidewall of the tire T to detach from the rim R.

FIG. 5 shows a tool and more specifically a lever L that is used in combination with the device D of FIGS. 1 to 4. The lever L includes a handle 40, a tire-engaging end 44 and a pivot portion 42 therebetween. The lever L is used to facilitate the positioning of the tire T within the device D by lifting the tire T so that it vertically clears the lower jaw 16 and can be displaced sideways until it is positioned between the upper and lower jaws 14 and 16 and in contact with the abutment rod 32.

FIGS. 6 and 7 illustrate a second embodiment of a device D′ for unseating tire beads from rims, which is similar to device D of FIGS. 1 to 4 but wherein the upper and lower jaws 14′ and 16′ are curved such as to generally follow the side of the rim R. Also, in device D′, the piston end of the cylinder 10 is connected to the upper lever arm 30′ instead of to the lower lever arm 26′.

FIG. 8 shows a third embodiment of a device D″ for unseating tire beads from rims, which is similar to the device of FIG. 1, but includes peripheral components, such as a casing 46a and 46b. FIGS. 8a to 8e are detailed views of some of the components of the device D″ of FIG. 8.

FIG. 9 shows a fourth embodiment of a device D′″ for unseating tire beads from rims, which is oriented horizontally, whereby the tire T is disposed vertically in the device D′″. The distal jaw 16′″ is fixed, whereas the proximal jaw 14′″ is mobile and adapted to displace substantially horizontally (see arrows 54). A handle 50 and a wheel 52 are provided for allowing the device D′″ to be displaced, when not in use, in a way similar to a loading dolly. The device D′″ includes a mechanism for allowing the height of the tire T to be adjusted so that the sidewalls thereof are positioned properly, elevation-wise, with respect to the jaws 14′″ and 16′″ in order to ensure that the jaws 14′″ and 16′″ engage the tire T close to the rim R. Such an adjustment mechanism can take the form of a support plate or platform disposed under the tire T and capable of being displaced vertically, e.g. via a manual or motorized vertical screw arrangement, by a small scissor lift, etc.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the disclosure as defined in the claims appended hereto.

1. A device for unseating beads of a tire from a rim onto which the tire is mounted, comprising first and second facing tire-engaging members adapted to receive the tire therebetween and adapted to move relative to one another towards the tire so as to engage the tire adjacent the rim, said first and second tire-engaging members being adapted for engaging first and second sidewalls of the tire such that a displacement of the first and second tire-engaging members towards each other causes said tire-engaging members to engage the first and second sidewalls of the tire so as to detach the tire from the rim.

2. The device of claim 1, wherein the first and second facing tire-engaging members include respectively upper and lower jaws and wherein the tire is positioned substantially horizontally therebetween.

3. The device of claim 1, wherein the first tire-engaging member is mobile whereas the second facing tire-engaging member is fixed.

4. The device of claim 2, wherein the upper jaw is mobile whereas the lower jaw is fixed.

5. The device of claim 4, wherein a cylinder is provided for displacing the upper jaw towards and away from the lower jaw.

6. The device of claim 4, wherein said upper and lower jaws are substantially vertical plates respectively mounted to a pivoting lever structure actuated by the cylinder and to a fixed base of the device.

7. The device of claim 1, wherein an adjustable tire abutment is provided, said tire abutment being adapted to be positioned so that when a threaded section of the tire is abutted thereto, said upper and lower jaws face respective sidewalls of the tire adjacent the rim.

8. The device of claim 2, wherein a separate lever is provided for elevating part of the tire higher than the lower jaw and facilitating the positioning of the tire between the upper and lower jaws.

9.-10. (canceled)

11. The device of claim 1, wherein at least one of the first and second facing tire-engaging members is curved such as to generally follow the edge of the rim.

12. (canceled)

13. The device of claim 1, wherein the first and second facing tire-engaging members include respectively proximal and distal jaws and wherein the tire is positioned substantially therebetween.

14. (canceled)

15. The device of claim 13, wherein the proximal jaw is mobile whereas the distal jaw is fixed.

16. The device of claim 15, wherein a cylinder is provided for displacing the proximal jaw towards and away from the distal jaw.

17. The device of claim 15, wherein said proximal and distal jaws are substantially horizontal plates respectively mounted to a pivoting lever structure actuated by the cylinder and to a fixed base of the device.

18. The device claim 1, wherein a tire positioning mechanism is provided, said tire positioning mechanism being adapted to adjust an elevation of the tire relative to the proximal and distal jaws.

19.-20. (canceled)

21. The device of claim 17, wherein the horizontal plates are narrow for limiting the area of engagement thereof with the sidewalls.

22. The device of claim 21, wherein at least one of the proximal and distal jaws is curved such as to generally follow the edge of the rim.

23. The device of claim 22, wherein both the proximal and distal jaws are curved.

24. The device of claim 18, wherein the tire positioning mechanism comprises a support plate adapted to receive the tire thereon and capable of being displaced vertically.

25. The device of claim 24, wherein the tire positioning mechanism comprises one of a manual vertical screw arrangement, a motorized vertical screw arrangement, and a scissor lift.

26. The device of claim 1, wherein said tire-engaging members are adapted to engage the first and second sidewalls of the tire so as to detach both beads of the tire from the rim.
